(19) United States
(12) Patent Application Publication
(10) Pub. No.: US 2026/0351506 A1
(43) Pub. Date: Nov. 5, 2026

(54) STRESS COMPENSATOR FOR FLAT EMITTER

(71) Applicant: GE Precision Healthcare LLC, Waukesha, WI (US)

(72) Inventors: Kevin S Kruse, Muskego, WI (US); Evan M Lampe, West Milwaukee, WI (US)

(21) Appl. No.: 19/197,465

(22) Filed: May 2, 2025

(51) Int. Cl. H01J 35/06

(52) U.S. Cl. CPC H01J 35/064; H01J 35/066

(57) ABSTRACT

Various methods and systems are provided for a stress compensator for a flat emitter for a cathode of an X-ray tube. In one example, an emitter assembly comprises a flat emitter formed as a planar emission surface having a serpentine pattern. The emitter assembly further comprises a stress compensator that is selectively coupled to the flat emitter at a first end of the flat emitter. The stress compensator comprises a spring formed by a number of linear portions arranged in parallel, where each linear portion of the number of linear portions is coupled to a preceding and/or following linear portion by a turn.

### FIELD

Embodiments of the subject matter disclosed herein relate to X-ray tubes, and more particularly to a thermal expansion and centrifugal force stress compensator for a flat emitter of a cathode.

### BACKGROUND

In an X-ray tube, ionizing radiation is created by accelerating electrons in a vacuum from a cathode to an anode via an electric field. The electrons originate from an emitter of the cathode. The emitter may be a flat surface emitter, also referred to as a “ribbon emitter” and/or a “flat emitter”, that is formed with an electron emissive material, such as tungsten. The flat emitter has a flat electron emission surface that is divided by slots with a number of interconnects to create either a single meandering current carrying path (also a “serpentine” path) that includes a number of spaced but interconnected ribbons, or multiple parallel current carrying paths. The flat emitter may be positioned on the cathode with the flat electron emission surface orthogonal to the anode. The flat emitter may be heated by flowing a current therethrough to liberate electrons and accelerate the electrons toward the anode. For example, flat emitters may operate at temperatures above 2000 °C in some examples, the X-ray tube may be used with an X-ray imaging system, such as a Computed Tomography (CT) imaging system that includes a rotating gantry, and thus the X-ray tube is rotated around an object being imaged to provide different imaging views of the object. Rotation of the gantry and, thus, the X-ray tube may exert centrifugal forces on the flat emitter that can be in excess of 30 G.

### BRIEF DESCRIPTION

Various systems are provided herein for a stress compensator for an emitter assembly of a cathode. The stress compensator is selectively coupled to a flat emitter of the emitter assembly at a first end of the flat emitter. The flat emitter is formed as a substantially flat sheet with a serpentine pattern. The stress compensator comprises a spring formed by a number of linear portions arranged in parallel, where each linear portion of the number of linear portions is coupled to a preceding linear portion and/or a following linear portion by a turn. The emitter assembly, including the flat emitter and the stress compensator, may be positioned in a cathode assembly of an X-ray tube. The X-ray tube may further include an anode assembly spaced apart from the cathode assembly.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 shows a schematic representation of an X-ray imaging system according to an exemplary embodiment;

FIG. 2 shows a block diagram of the X-ray imaging system illustrated in FIG. 1;

FIG. 3 shows a schematic of a cross-sectional view of a portion of an X-ray tube which may be included in the imaging system of FIG. 1 and/or FIG. 2;

FIG. 4 shows a perspective view of a cathode cup of the X-ray tube, where the cathode cup includes an emitter assembly that is positioned in the cathode cup by a first positioning support and a second positioning support;

FIG. 5 show a top-down view of the emitter assembly of the cathode cup;

FIG. 6 shows a top-down view of a stress compensator of the emitter assembly;

FIG. 7 shows a perspective view of the stress compensator;

FIG. 8 shows a perspective view of the second positioning support of the cathode cup;

FIG. 9 shows a perspective view of the first positioning support of the cathode cup;

FIG. 10 shows various views of the first positioning support at various manufacturing stages;

FIG. 11 shows a perspective view of the cathode cup of the X-ray tube where the cathode cup includes an emitter assembly that is positioned in the cathode cup by a third positioning support and a fourth positioning support;

FIG. 12 show a perspective view of the emitter assembly, including a second configuration of the stress compensator;

FIG. 13 shows a top-down view of a stress compensator of the emitter assembly;

FIG. 14 shows a perspective view of the stress compensator;

FIG. 15 shows a perspective view of the fourth positioning support of the cathode cup;

FIG. 16 shows a perspective view of the flat emitter coupled to the fourth positioning support;

FIG. 17 shows a perspective view of the third positioning support; and

FIG. 18 shows a perspective view of the second configuration of the stress compensator positioned in the third positioning support.

### DETAILED DESCRIPTION

The following description relates to various embodiments of a stress compensator for a flat emitter of a cathode of an X-ray tube. The X-ray imaging system may be an interventional radiography imaging system, a fluoroscopic imaging system, a mammography imaging system, a fixed or mobile radiography (RAD) imaging system, a tomographic imaging system, a computed tomography (CT) imaging system, and so on. The X-ray imaging system includes an X-ray source (e.g., an X-ray tube) to generate irradiating X-ray beams. The X-ray tube includes an anode assembly and a cathode assembly, the latter of which includes a cathode. The cathode assembly includes an emitter mounted in a cathode cup.

Conventional X-ray imaging systems may use an emitter positioned in a focusing cup of a cathode of an X-ray tube to emit electrons and generate X-ray beams. The emitter may be a flat emitter having a substantially planar surface. Rather than being formed of a coiled filament/wire, the flat emitter, also referred to as a ribbon emitter, is a substantially flat sheet of tungsten with a serpentine pattern cut through the flat sheet. The flat emitter may be more efficient than a coiled emitter because the flat surface of the emitter provides more focused emission of electrons and emits more electrons per surface area compared to the coiled filament. An ongoing goal of X-ray tube development is to design a more emissive emitter that provides a brighter electron source (e.g., more electrons per surface area).

An electric current is transmitted through an emitter and heats the emitter to emit electrons. Electric current may be provided to the emitter via a source that is coupled to emitter. The current may travel along the serpentine pattern of the flat emitter to heat up the emitter and cause electron emission. When current is directly applied through the emitter to generate heat in the emitter and cause electron emission, the emitter surface may reach temperatures typically above 2000 °C. At these temperatures, the properties of the material forming the emitter, such as creep resistance and yield strength, may be greatly reduced from room temperature values. The high operating temperatures at which the emitter is operated may also induce thermal strains due to thermal expansion of the emitter. If the emitter is fixed in space, thermal expansion of the emitter may cause ligaments of the serpentine pattern of the emitter to touch, causing an electrical short that may halt electron emission and/or degrade the emitter. The high operating temperatures may also cause the thermal expansions of a lower temperature sub-structure, such as supports that position the emitter in the X-ray tube. For example, in conventional X-ray tube designs, the emitter may be suspended and/or positioned on insulators in the cathode cup.

X-ray imaging further includes rotating the X-ray tube around an imaging area for acquiring the projection data, for example, at different energy levels. Rotating the X-ray tube about a central axis imparts a centrifugal force on the X-ray tube, and therefore on the emitter. The centrifugal force may be, for example, 30 G, 50 G, or more. The centrifugal force experienced by the emitter may cause the emitter to move and short out. For example, the emitter may move within the cathode cup and/or may deform in shape, which may cause sections of the serpentine pattern to touch each other, and/or to touch the cathode cup, and short out. Additionally, the G load in a radial direction caused by rotating of the X-ray tube may push on the emitter and causes the emitter to compress like a spring. Compression may cause ligaments of the serpentine pattern to compress and touch, which short out the emitter. This is undesirable, as shorting may degrade the emitter and render the emitter, and therefore the X-ray tube, inoperable.

A combination of high centrifugal force, thermal strains, and reduced material properties may result in the emitter deforming in the direction of the centrifugal force, which may cause the slots dividing the emission surface to close such that adjacent ribbons come into contact with one another. A closed slot may create an electrical short, reducing the temperature of the emission area and impacting the emission profile of the emitter. Thus, it is desirable to prevent shorting of the emitter when high external force (e.g., centrifugal force due to rotation) and high temperature is applied to the emitter.

A design for an emitter assembly is desired that is resistant to shorts caused by thermal expansion, centrifugal force, and compression of the emitter. Described herein is an emitter assembly, comprising a flat emitter and a stress compensator that is selectively coupled to the flat emitter. The stress compensator provides a compliant element in the emitter assembly that is not fixedly coupled to and/or integrated in the flat emitter itself. As described herein, “compliant” defines a flexible element, mechanism, or assembly that achieves force and motion transmission through elastic body deformation. This may enable use of different types of emitters and/or use of the emitter assembly in different cathode assembly configurations. Further, the stress compensator may have different configurations that emphasize different benefits of the compliant design, such as increasing the compliance of the emitter with thermal expansion during heating and/or due to rotation of the X-ray tube in which the emitter is positioned.

Technical advantages of the herein disclosed system include a simple and compact emitter assembly for generating X-ray beams that does not significantly increase a complexity, footprint, or weight of the cathode (also herein, “cathode assembly”) while simultaneously increasing an efficiency of the emitter. Degradation of the emitter due to shorting is reduced by coupling a stress compensator to an end of the emitter, where the stress compensator includes a spring that provides deformation flexibility.

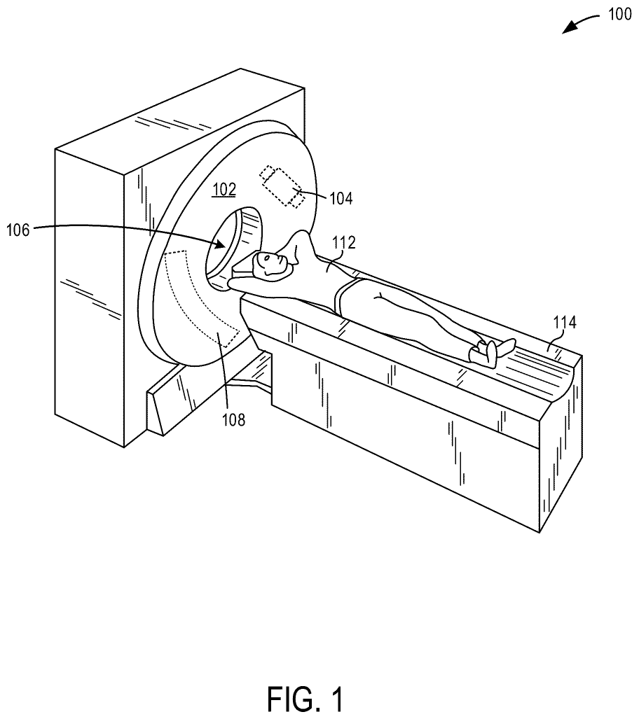

Before further discussion of the stress compensator for the emitter assembly, an example imaging system in which the emitter assembly may be implemented is shown. FIG. 1 shows a schematic representation of an embodiment of an X-ray imaging system 100 configured both to acquire original image data and to process the image data for display and/or analysis in accordance with exemplary embodiments. It will be appreciated that various embodiments are applicable to numerous X-ray imaging systems implementing an X-ray tube, such as X-ray radiography (RAD) imaging systems, X-ray mammography imaging systems, fluoroscopic imaging systems, tomographic imaging systems, or computed tomography (CT) imaging systems. The following discussion of the X-ray imaging system 100 is merely an example of one such implementation and is not intended to be limiting in terms of modality.

The X-ray imaging system 100 may be configured as one or more of an interventional radiography imaging system, a mammography imaging system, a fixed or mobile RAD imaging system, and so on. Particularly, the X-ray imaging system 100 is configured to image a subject 112 such as a patient, an inanimate object, one or more manufactured parts, and/or foreign objects such as dental implants, stents, and/or contrast agents present within the body. In one embodiment, the X-ray imaging system 100 includes a gantry 102, which in turn, may further include at least one X-ray source 104 configured to project a beam of X-ray radiation for use in imaging the subject 112 laying on a table 114. Specifically, the X-ray source 104 is configured to project the X-ray radiation beams towards a detector assembly 108 positioned on the opposite side of the gantry 102. In certain embodiments, the X-ray source 104 is configured to traverse different angular positions around the subject 112 for acquiring desired projection data. Accordingly, the gantry 102 and the components mounted thereon may be configured to rotate about a center of rotation 106 for acquiring the projection data, for example, at different energy levels. Alternatively, in embodiments where a projection angle relative to the subject 112 varies as a function of time, the mounted components may be configured to move along a general curve rather than along a segment of a circle.

Although FIG. 1 depicts a single X-ray source 104, in certain embodiments, multiple X-ray tubes and detectors may be employed to project a plurality of X-ray radiation beams for acquiring projection data at different energy levels corresponding to the patient. In some embodiments, the X-ray source 104 may enable dual-energy gemstone spectral imaging (GSI) by rapid peak kilovoltage (kVp) switching. In some embodiments, the X-ray detector employed is a photon-counting detector which is capable of differentiating X-ray photons of different energies. In other embodiments, two sets of X-ray tubes and detectors are used to generate dual-energy projections, with one set at low-kVp and the other at high-kVp. It should thus be appreciated that the methods described herein may be implemented with single energy acquisition techniques as well as dual energy acquisition techniques.

In some CT imaging system configurations, an X-ray tube projects a cone-shaped X-ray radiation beam which is collimated to lie within an X-Y-Z plane of a Cartesian coordinate system and generally referred to as an “imaging plane.” The X-ray radiation beam passes through an object being imaged, such as the patient or subject. The X-ray radiation beam, after being attenuated by the object, impinges upon an array of detector elements. The intensity of the attenuated X-ray radiation beam received at the detector assembly is dependent upon the attenuation of a radiation beam by the object. Each detector element of the array produces a separate electrical signal that is a measurement of the X-ray beam attenuation at the detector location. The attenuation measurements from all the detector elements are acquired separately to produce a transmission profile.

In some CT systems, the X-ray tube and the detector assembly are rotated with a gantry within the imaging plane and around the object to be imaged such that an angle at which the radiation beam intersects the object constantly changes. A group of X-ray radiation attenuation measurements, e.g., projection data, from the detector assembly at one gantry angle is referred to as a “view.” A “scan” of the object includes a set of views made at different gantry angles, or view angles, during one revolution of the X-ray tube and detector. It is contemplated that the benefits of the methods described herein accrue to medical imaging modalities other than CT, so as used herein the term “view” is not limited to the use as described above with respect to projection data from one gantry angle. The term “view” is used to mean one data acquisition whenever there are multiple data acquisitions from different angles, whether from a CT, positron emission tomography (PET), or single-photon emission CT (SPECT) acquisition, and/or any other modality including modalities yet to be developed as well as combinations thereof in fused embodiments.

The projection data is processed to reconstruct an image that corresponds to a two-dimensional slice taken through the object or, in some examples where the projection data includes multiple views or scans, a three-dimensional rendering of the object. One method for reconstructing an image from a set of projection data is referred to in the art as the filtered back projection technique. Transmission and emission tomography reconstruction techniques also include statistical iterative methods such as MLEM and ordered-subsets expectation-reconstruction techniques as well as iterative reconstruction techniques. This process converts the attenuation measurements from a scan into integers called “CT numbers” or “Hounsfield units,” which are used to control the brightness of a corresponding pixel on a display device.

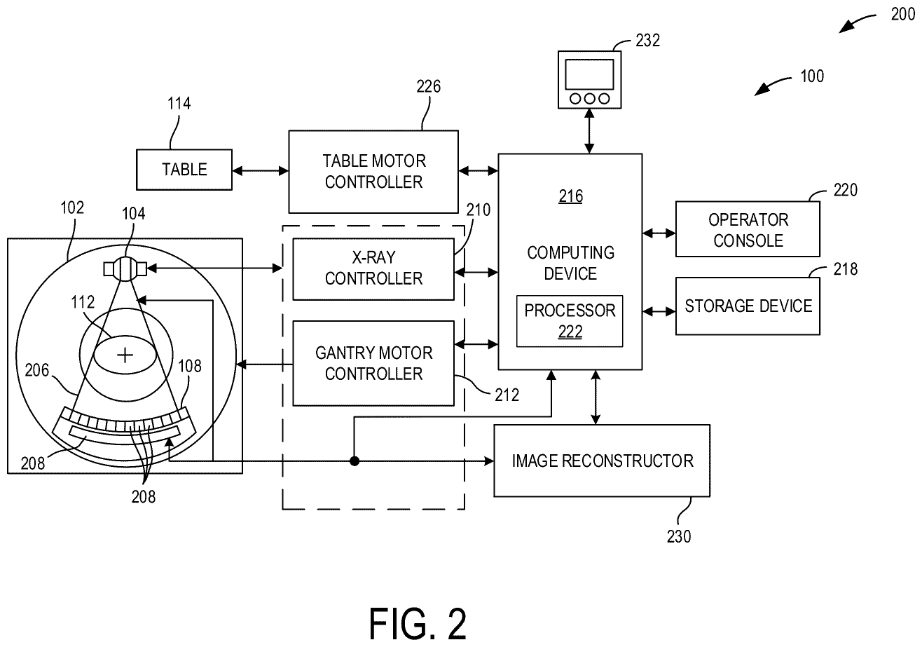

FIG. 2 shows further detail of the X-ray imaging system 100 of FIG. 1 in a block diagram 200. As shown in FIG. 2, X-ray imaging system 100 includes the X-ray source 104 configured to project a beam of X-rays 206 through the subject 112. The subject 112 may include a human subject, pieces of baggage, or other objects desired to be scanned. The X-ray source 104 may be one or more X-ray tubes producing X-rays 206 having a spectrum of energies that range, typically, from thirty (30) keV to two hundred (200) keV. The X-rays 206 pass through the subject 112 and, after being attenuated, impinge upon an array of detectors 208 of the detector assembly 108. Each detector module in the detector assembly 108 produces an analog electrical signal that represents the intensity of an impinging X-ray beam, and hence the attenuated beam, as it passes through the subject 112. In one embodiment, detector assembly 108 is a scintillator-based detector assembly that may be implemented as an energy integrating detector, however, it is also envisioned that direct-conversion type detectors or photon counting detectors (e.g., CdTe, CZT, Si detectors, etc.) may also be implemented.

The X-ray imaging system 100 includes an X-ray controller 210 that provides power and timing signals to the X-ray source 104. The X-ray imaging system 100 may further include a gantry motor controller 212 that controls a rotational speed and position of the gantry 102. In some examples, the X-ray imaging system 100 may include a table motor controller 226 configured to control a position of the table 114 on which the subject 112 is positioned (e.g., via one or more motors of the table 114). Rotation of the gantry 102 and operation of the X-ray source 104 are governed by a computing device 216 of the X-ray imaging system 100. The computing device 216 may include a processor 222 that is configured to send and receive signals to and from one or more of the X-ray controller 210, the gantry motor controller 212, and the table motor controller 226. Further, the computing device 216 may receive signals from the detector assembly 108 and generate an image corresponding to the subject 112 being scanned. The X-ray imaging system 100 may include an image reconstructor 230 configured to receive sampled and digitized X-ray data (e.g., from a data acquisition system of the computing device 216) and perform high speed image reconstruction. A reconstructed image may be applied as input to the computing device 216, and stored in a storage device 218.

The computing device 216 communicates with the processor 222 to enable an operator, using an operator console 220, to control the scanning parameters and to view the generated image. That is, the operator console 220 includes some form of operator interface, such as a keyboard, mouse, voice activated controller, or any other suitable input apparatus that allows an operator to control the X-ray imaging system 100 and view the reconstructed image or other data from the computing device 216 on a display unit 232. Additionally, the operator console 220 allows an operator to store the generated image in a storage device 218 which may include hard drives, floppy discs, compact discs, etc. The operator may also use the operator console 220 to provide commands and instructions to the computing device 216 for controlling an X-ray controller 210 that provides power and timing signals to the X-ray source 104.

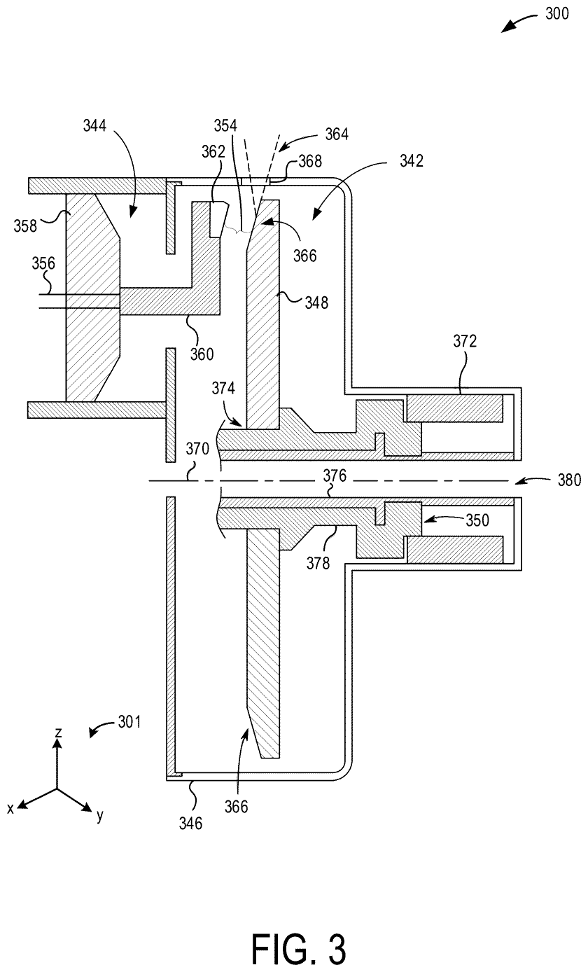

FIG. 3 illustrates a cross-sectional schematic view of an X-ray tube 300 which may be included in the imaging system of FIGS. 1 and/or 2. For example, the X-ray tube 300 may be an exemplary embodiment of the X-ray source 104 of FIG. 1 and/or of FIG. 2. An axis system 301 is provided in FIGS. 3-18 for reference. The z-axis may be a vertical axis (e.g., parallel to a gravitational axis), the y-axis may be a lateral axis (e.g., horizontal axis), and the x-axis may be a longitudinal axis, in one example. However, the axes may have other orientations, in other examples. FIGS. 3-18 are shown approximately to scale, although other relative dimensions may be used.

The X-ray tube 300 comprises an anode assembly 342 and a cathode assembly 344, both of which are housed in a frame 346. The frame 346 defines an area of relatively low pressure (e.g., a vacuum) compared to ambient, in which high voltages may be present. Further, the frame 346 may be positioned within a casing (not shown) filled with a cooling medium, such as oil, that may also provide high voltage insulation.

The anode assembly 342 includes an anode 348 with a target 366. The anode 348 and the target 366 may be a common component or may be separate components in of the X-ray tube 300. The anode 348 may be manufactured to include a number of metals or alloys, such as tungsten, molybdenum, copper, or any material that contributes to bremsstrahlung (e.g., deceleration radiation) when bombarded with electrons. The target 366 of the anode 348 may be selected to have a relatively high refractory value so as to withstand the heat generated by electrons impacting the anode 348. The anode assembly 342 further includes a rotor 372 and a stator (not shown) located outside the X-ray tube 300 and surrounding the rotor 372 for causing rotation of the anode 348 during operation. The anode 348 is supported for rotation by a bearing assembly 350, which, when rotated, also causes the anode 348 to rotate about a centerline 370 thereof. As such, the centerline 370 defines a rotational axis of the anode 348 and the bearing assembly 350. As shown, the anode 348 has an annular shape, which contains a circular opening 374 in the center thereof for receiving the bearing assembly 350. Different embodiments of the bearing assembly 350 can be formed, such as with a number of suitable ball bearings. In the illustrated exemplary embodiment, the bearing assembly 350 comprises a liquid metal hydrodynamic bearing having adequate load-bearing capability and acceptable acoustic noise levels for operation within the X-ray imaging system 100 of FIGS. 1-2. In general, the bearing assembly 350 includes a stationary component, such as a center shaft 376, and a rotating portion, such as a sleeve 378 to which the anode 348 is attached. While the center shaft 376 is described with respect to FIG. 3 as the stationary component of the bearing assembly 350 and the sleeve 378 is described as the rotating component of the bearing assembly 350, embodiments of the present disclosure are also applicable to embodiments wherein the center shaft 376 is a rotary shaft and the sleeve 378 is a stationary component. In such a configuration, the anode 348 would rotate as the center shaft 376 rotates.

The center shaft 376 may optionally include a coolant flow path 380 though which a coolant (not shown), such as oil, may flow to cool the bearing assembly 350. As such, the coolant enables heat generated from the anode 348 of the X-ray tube 300 to be extracted therefrom and transferred external from the X-ray tube 300. In straddle mounted X-ray tube configurations, the coolant flow path 380 extends along a longitudinal length of the X-ray tube 300, e.g., along the centerline 370. In alternative embodiments, the coolant flow path 380 may extend through a portion of the X-ray tube 300, such as in configurations where the X-ray tube 300 is cantilevered when placed in an imaging system.

The cathode assembly 344 includes a central insulating shell 358 from which a mask 360 extends. Mask 360 encloses a series of electrical leads 356, which extend to a cathode cup 362 mounted at the end of mask 360. The cathode cup 362 includes an emitter assembly (not shown) that is electrically coupled to one or more leads of the series of electrical leads 356. A space 354 between the cathode cup 362 and the anode 348 is evacuated (e.g., as part of the vacuum of the X-ray tube 300) in order to minimize electron collisions with other atoms and to maximize an electric potential.

In operation of the X-ray tube 300, an electron beam is produced by the cathode assembly 344. In particular, the emitter assembly of the cathode assembly 344 receives one or more electrical signals via the series of electrical leads 356. The electrical signal(s) heat up an emitter of the emitter assembly, causing the emitter to emit electrons in an electron beam. The electron beam occupies the space 354 between the cathode cup 362 and the target 366 of the anode 348. The electrical signals may be timing/control signals that cause the cathode assembly 344 to emit the electron beam at one or more energies and at one or more frequencies. The electrical signals may also at least partially control the potential between the cathode assembly 344 and the anode 348. In some embodiments, the cathode cup 362 serves as an electrostatic lens that focuses electrons emitted from the emitter to form the electron beam. X-rays 364 are produced when high-speed electrons of the electron beam are suddenly decelerated when directed from the cathode assembly 344 to the target 366 formed on the anode 348 via a potential difference therebetween of, for example, sixty thousand (60,000) volts or more in the case of CT applications. The X-rays 364 are emitted through a radiation emission passage 368 formed in the frame 346 toward a detector assembly, such as the detector assembly 108 of FIG. 1 and/or of FIG. 2.

To avoid overheating of the anode 348 when bombarded by the electrons, the rotor 372 rotates the anode 348 at a high rate of speed (e.g., 90 to 250 Hz) about the centerline 370. In addition to the rotation of the anode 348 within the frame 346, in a CT application, the X-ray tube 300 as a whole may be caused to rotate about an object, such as the subject 112 of the X-ray imaging system 100 in FIGS. 1 and 2, at rates of typically 1 Hz or faster. For example, the gantry 102 and elements thereof (e.g., including the X-ray source 104) may be configured to rotate about the center of rotation 106.

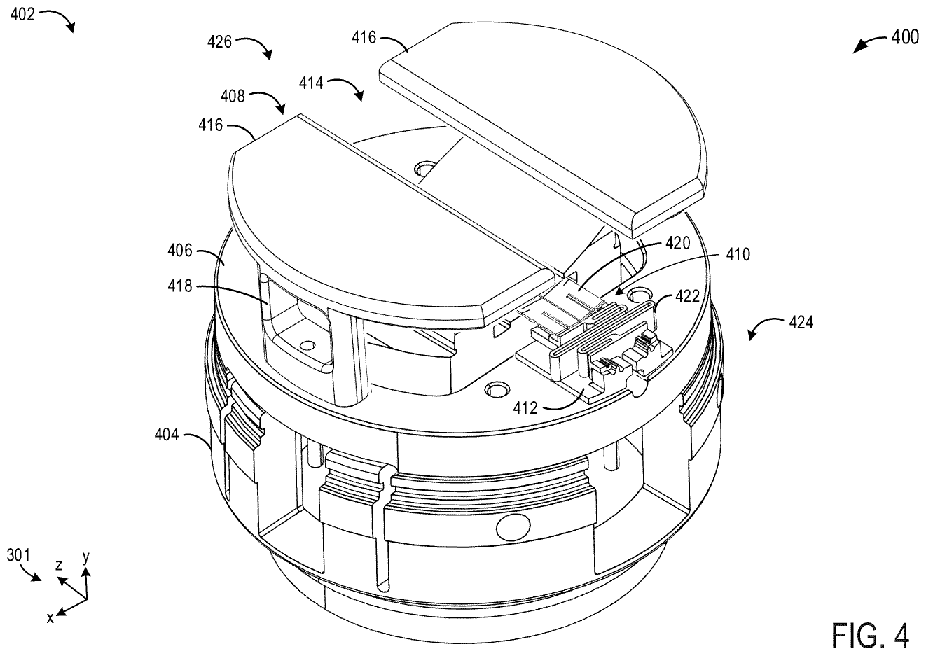

FIG. 4 shows a perspective view 400 of a cathode cup 402, which may be an example of the cathode cup 362 of the cathode assembly 344 of FIG. 3. Elements of the cathode cup 402 are positioned as illustrated by the axis system 301. Elements of the cathode cup 402, and/or elements coupled thereto, which are equivalent to elements of the X-ray tube 300 of FIG. 3 are similarly numbered.

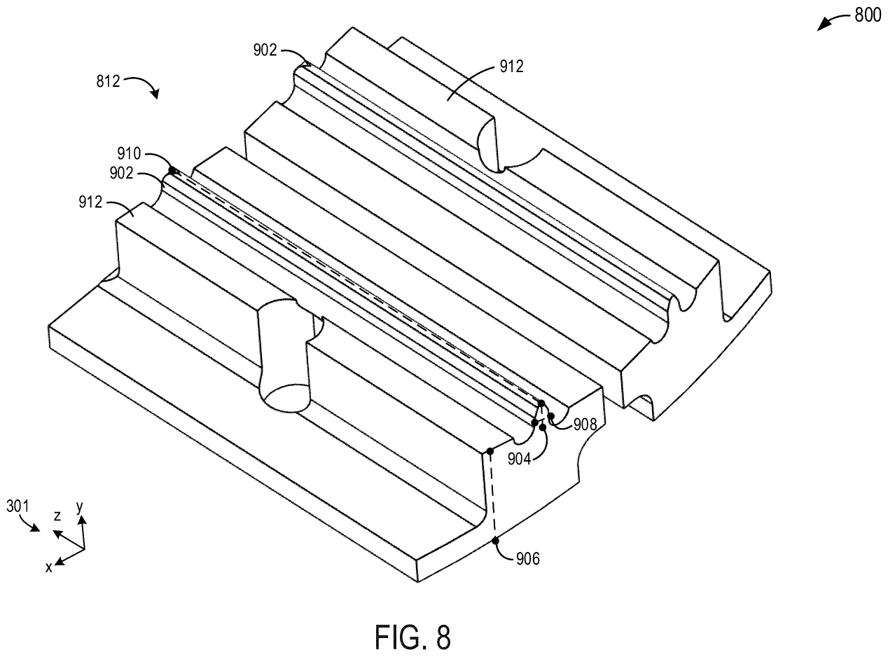

The cathode cup 402 may comprise a base 404, an insulator 406, a focusing element 408, and an emitter assembly 410. The cathode cup 402 may further include a first positioning support 412 and a second positioning support (not visible in FIG. 4) that are configured to position the emitter assembly 410 within the cathode cup 402. The insulator 406 may be a ceramic insulator (e.g., formed of ceramic) in some examples, and in other examples the insulator 406 may be formed of material that sufficiently insulates the base 404 from the focusing element 408 and the emitter assembly 410. The base 404 may be formed of metal such as, for example, nickel, steel, kovar, and/or niobium. The focusing element 408 may include one or more features 416 that have the same or a similar geometry that is configured to focus emitted electrons (e.g., from the emitter assembly 410) into a single electron beam. In some examples, the focusing element 408 may have a substantially circular shape (e.g., in the x-z plane) where each feature of the one or more features 416 of the focusing element 408 are shaped as a rectangular shape with one rounded side (e.g., forming a portion of a circumference of the substantially circular shape of the focusing element 408), and where there is a channel 414 between the one or more features 416. The channel 414 may be adjusted based on a width and a strength of an emitter of the emitter assembly 410. Each of the one or more features 416 of the focusing element 408 further includes a leg support 418 that extends perpendicular to, and may be a continuous single architecture with, the substantially circular shape of the focusing element 408. The emitter assembly 410 comprises a flat emitter 420 and a stress compensator 422. The stress compensator 422 may be selectively coupled to the flat emitter 420. For example, the flat emitter 420 may be coupled to the stress compensator 422 via a snap-fit, a weld, brazing, or other coupling. The emitter assembly 410 may be positioned in the cathode cup 402 by coupling the stress compensator 422 to the first positioning support 412 and coupling the flat emitter 420 to the second positioning support. Further detail regarding geometry of each of the first positioning support 412 and the second positioning support are described with respect to FIGS. 8-10. As described with respect to FIG. 3, the cathode cup 362 may be electrically coupled to one or more leads of the series of electrical leads 356 (e.g., ribbons, wires, cables, pins or other electrical connection components). The series of electrical leads 356 may be configured to provide different electrical current to different elements. For example, a first current may be provided by leads of the series of electrical leads 356 that are coupled to the focusing element 408. A second current may be provided by leads of the series of electrical leads 356 that are coupled to the first positioning support 412. A third current may be provided by leads of the series of electrical leads 356 that are coupled to the second positioning support. One or more of the first current, the second current, and/or the third current may be the same or different. For example, the first current supplied to the focusing element 408 may be configured to focus electrons emitted by the emitter assembly. The second current and the third current supplied to the first positioning support 412 and the second positioning support, respectively, may be configured to heat up the flat emitter 420 of the emitter assembly 410 to a temperature at which the flat emitter 420 emits electrons.

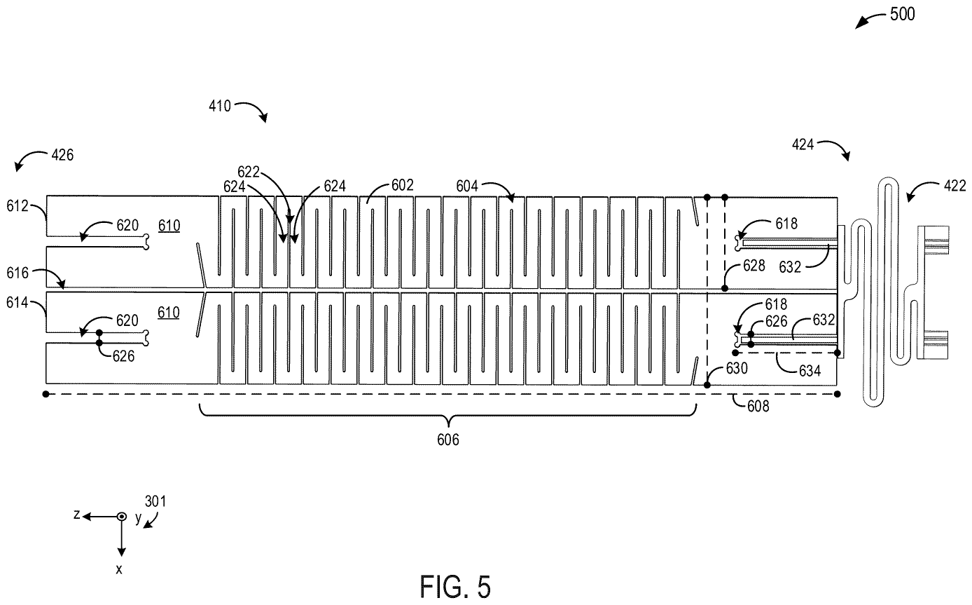

FIG. 5 show a top-down view 500 of the emitter assembly 410 of the cathode cup 402. As briefly described with respect to FIG. 4, the emitter assembly 410 comprises the flat emitter 420 and the stress compensator 422. The flat emitter 420 may be a substantially flat emitter having a planar emission surface 602. The flat emitter 420 may include a serpentine pattern 604 for at least a first portion 606 of an emitter length 608 of the flat emitter 420. The serpentine pattern 604 comprises a series of ligaments that are connected and have gaps between each curve of the serpentine pattern 604. The serpentine pattern 604 may be cut through one or more of a substantially flat sheet 610 that forms the flat emitter 420.

The flat emitter 420 may be a two-pass ribbon emitter comprising a first pass 612 and a second pass 614 each having the serpentine pattern 604 along the first portion 606 of the emitter length 608. The first pass 612 and the second pass 614 may be spaced apart from each other by a gap 616 that extends along the emitter length 608. Described another way, the first pass 612 and the second pass 614 may be structurally independent from each other. In some examples, the flat emitter 420 may include a single pass (e.g., either the first pass 612 or the second pass 614), or more than two passes. At each of the first end 424 and the second end 426, the first pass 612 and the second pass 614 may include a cutout that extends partially along the emitter length 608. For example, the flat emitter 420 comprises a first cutout 618 at the first end 424 (e.g., of each of the first pass 612 and the second pass 614). The flat emitter 420 further comprises a second cutout 620 at the second end 426 (e.g., of each of the first pass 612 and the second pass 614). Both the first cutout 618 and the second cutout 620 extend through the planar emission surface 602 of the flat emitter 420 (e.g., parallel to the y-axis of the axis system 301). Gaps 622 (e.g., parallel to the x-axis of the axis system 301) between each section 624 of the serpentine pattern may be perpendicular to the first cutout 618 and the second cutout 620 (e.g., parallel to the z-axis of the axis system 301).

Each of the first cutout 618 and the second cutout 620 may have a first width 626 that is less than a pass width 628 of each of the first pass 612 and the second pass 614, and that is less than an emitter width 630 of the flat emitter 420. The one or more of the first cutout 618 and the second cutout 620 may be configured to receive a coupling 632 and couple the flat emitter 420 to the stress compensator 422, such that each of the first pass 612 and the second pass 614 of the flat emitter 420 may be coupled to the stress compensator 422. Further, one or more of the first cutout 618 and the second cutout 620 may be used to couple each of the first pass 612 and the second pass 614 of the flat emitter 420 to the second positioning support, as further described with respect to FIG. 8.

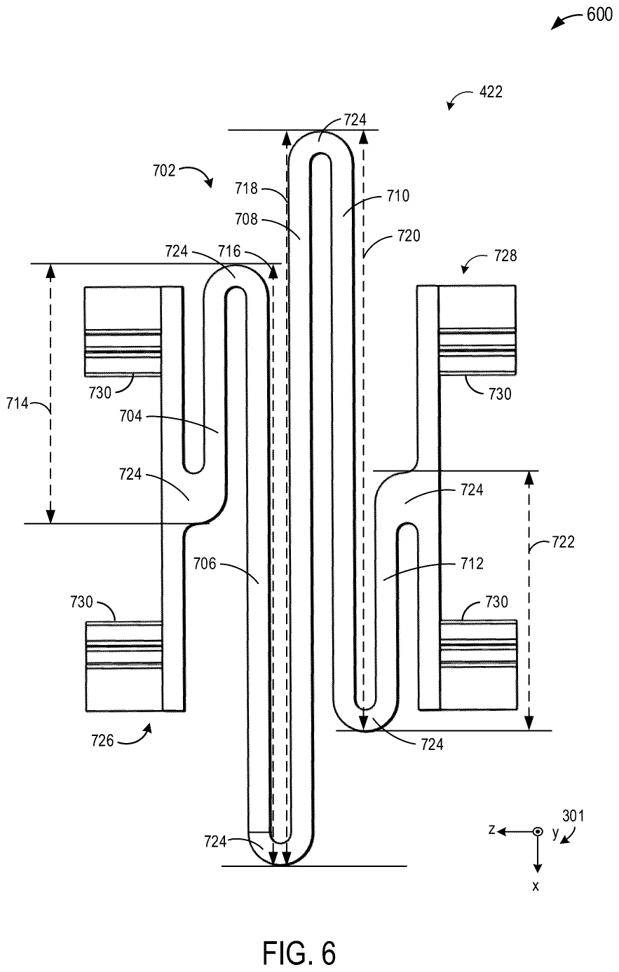

FIG. 6 shows a top-down view 600 of the stress compensator 422. The stress compensator 422 may be formed of one or more of niobium, molybdenum, steel alloy, tungsten-uranium alloy, and/or another refractory material. The stress compensator 422 comprises a spring 702 formed by a number of linear portions arranged in parallel, where each linear portion of the number of linear portions is coupled to a preceding and/or following linear portion by a turn. The number of linear portions may include a first linear portion 704 having a first length 714, a second linear portion 706 having a second length 716, a third linear portion 708 having a third length 718, a fourth linear portion 710 having a fourth length 720, and a fifth linear portion 712 having a fifth length 722. A first ratio of the second length 716 to the first length 714 may be greater than or equal to three. The third length 718 of the third linear portion 708 may be greater than each of the first length 714 and the second length 716. The fourth length 720 of the fourth linear portion 710 may be equal to the second length 716. The fifth length 722 of the fifth linear portion 712 may be equal to the first length 714. A second ratio of the fourth length 720 to the fifth length 722 may be the same as or different from the first ratio. For example, the second ratio may also be 3, or may be 2, 5, or another value. Values of the first ratio, the second ratio, and the number of linear portions may assist in preventing undesired in-plane rotation and/or deformation of the spring 702. The first ratio, the second ratio, and/or the number of linear portions of the spring 702 may be “tuned” (e.g., adjusted) such that the stress compensator 422 provides compliance to give the emitter (e.g., the flat emitter 420) to which the stress compensator 422 is coupled the same stiffness along the emitter length (e.g., the emitter length 608).

Each linear portion of the number of linear portions is coupled to a preceding and/or following linear portion by a turn 724. For example, the first linear portion 704 is coupled to the second linear portion 706 by the turn 724. The second linear portion 706 is further coupled to the third linear portion 708 by the turn 724. The third linear portion 708 is also coupled to the fourth linear portion 710 by the turn 724. The fourth linear portion 710 is also coupled to the fifth linear portion 712 by the turn 724. In this way, the spring 702 is formed of a continuous, serpentine path.

The stress compensator 422 further includes a set of coupling extensions that have coupling elements that are complementary to, and enable coupling of the stress compensator 422 with, an emitter (e.g., the flat emitter 420). A first coupling extension 726 of the set of coupling extensions may include one or more of a coupling element 730. The first coupling extension 726 may be coupled to the first linear portion 704 by the turn 724. In the example described herein, the first coupling extension 726 may include two coupling elements 730 that are complementary to the first cutout(s) 618 of the flat emitter 420. A second coupling extension 728 may be coupled to the fifth linear portion 712. The second coupling extension 728 may be coupled to the second linear portion 706 by the turn 724. Geometry of the first coupling extension 726 and the second coupling extension 728 may be adjusted based on a type of emitter to which the stress compensator 422 is to be coupled. For example, in emitter assemblies where a single pass emitter is used, the first coupling extension 726 may include a single coupling element 730. In some examples, the first coupling extension 726 and the second coupling extension 728 may have the same geometry. For example, when the first ratio and the second ratio are the same, the first coupling extension 726 and the second coupling extension 728 may have the same geometry as each other, which enables the stress compensator 422 to be coupled to the flat emitter 420 at either of the first coupling extension 726 or the second coupling extension 728, and the stress compensator 422 provide the same thermal expansion and centrifugal force stress compliance to both the first pass 612 and the second pass 614 of the flat emitter 420. Each coupling element 730 of the first coupling extension 726 and/or the second coupling extension 728 may extend perpendicular to lengths (e.g., the first length 714, the third length 718, etc.) of the number of linear portions of the spring 702. In some examples, the first coupling extension 726 and/or the second coupling extension 728 may be omitted from the stress compensator 422 (e.g., when the stress compensator 422 may be coupled to an emitter or other element on one side of the spring, and/or when the stress compensator 422 is coupled to the emitter via other means).

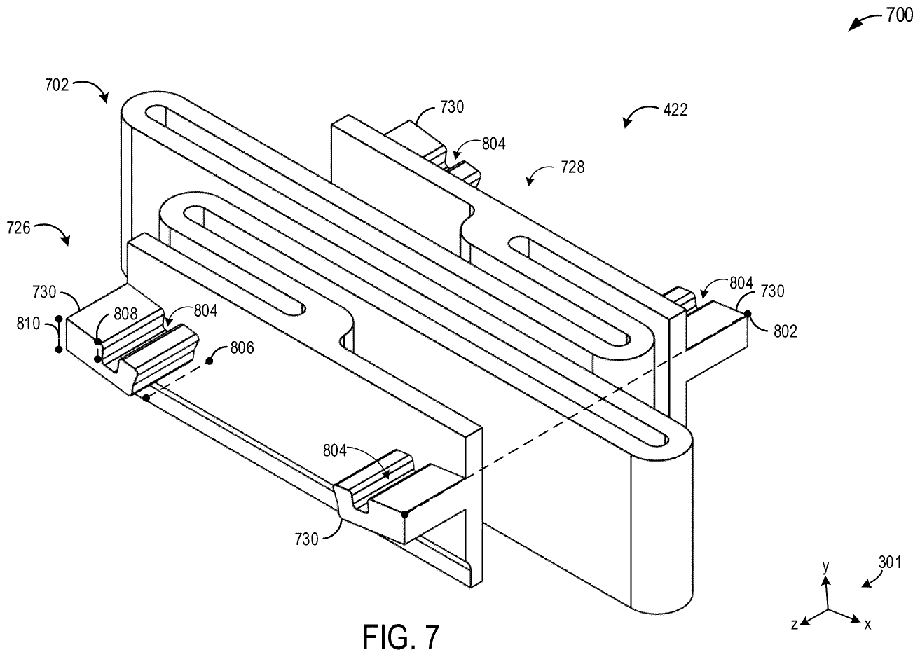

Turning to FIG. 7, a perspective view 700 is shown of the stress compensator 422. The first coupling extension 726 and the second coupling extension 728 stress compensator 422 may include a groove 804 in each coupling element 730. The groove 804 may extend a coupling element length 806 of the coupling element 730. The groove 804 may further extend a first portion 808 of a coupling element height 810 of the coupling element 730. The groove 804 may be configured to receive a coupling (not shown in FIG. 7) or other element that may be used to couple the stress compensator 422 to the flat emitter 420. For example, the coupling may be the coupling 632 of FIG. 5.

Returning to FIG. 5, the coupling 632 is shown positioned in the groove 804 of each coupling element 730 of the first coupling extension 726, and in the cutout 618 of the flat emitter 420 at the first end 424. The coupling 632 may be a cylindrical rod, a planar piece, and/or have another geometry with a length that is parallel to and less than a cutout length 634 of the first cutout 618 (e.g., parallel to the z-axis of the axis system 301). The coupling 632 may further have a width that is parallel to and less than the first width 626 of the first cutout 618 (e.g., parallel to the x-axis of the axis system 301). The flat emitter 420 may be coupled to the stress compensator 422 by sliding, pressing, snap-fitting, or otherwise inserting the coupling 632 into one or more groove 804 of the stress compensator 422 and into one or more of the first cutout 618 and the second cutout 620 of the flat emitter 420. In some examples, the flat emitter 420 may be welded or otherwise fixedly coupled to the stress compensator 422 via the coupling 632. Welding the stress compensator 422 to the flat emitter 420 via the coupling 632 may allow the stress compensator 422 to conduct current. When the flat emitter 420 is formed of two independent single passes (e.g., the first pass 612 and the second pass 614), welding both of the first pass 612 and the second pass 614 to the stress compensator 422 enables current to be conducted to each of the first pass 612 and the second pass 614 via the stress compensator 422, thus removing demand for an emitter-emitter weld between the first pass 612 and the second pass 614.

Positioning the emitter assembly 410 having the stress compensator 422 in a cathode cup (e.g., the cathode cup 402) may include additional manufacturing demands for the cathode cup. Conventional emitter assemblies may include stress compensators that are directly integrated into the emitter, such as being continuous with an emission region at an end of the emitter. Conventional emitters with integrated stress compensators may thus be coupled to positioning elements of the cathode cup at the first end and the second end of the emitter, where positioning elements at each end may have the same geometry. In the emitter assembly 410 described herein, the stress compensator 422 is selectively coupled to the flat emitter 420 at the first end 424. Thus, the first positioning support 412 at the first end 424 may have a geometry that is different from the second positioning support at the second end 426 in order to accommodate the stress compensator 422.

FIG. 8 shows a perspective view 800 of a second positioning support 812 (e.g., the second positioning support described with respect to FIGS. 4-7. The second positioning support 812 may be an example of a conventional positioning support that is used to support different types of emitters, including those that have stress compensators integrated in a body of the emitter. The second positioning support 812 comprises one or more of an emitter support 902 that is complementary to the second cutout 620 of the flat emitter 420. The emitter support 902 may extend vertically for a support height 904 that is greater than a base height 906 of the second positioning support 812. The emitter support may have a support width 908 that is less than the first width 626 of the second cutout 620 of the flat emitter 420. The emitter support 902 may further have a support length 910 that is less than or equal to the cutout length 634 of the second cutout 620. The second positioning support 812 may be coupled to the second end 426 of the flat emitter 420. The emitter support 902 may be inserted into the second cutout 620 at the second end 426 of both the first pass 612 and the second pass 614 of the flat emitter 420. Similar to the coupling 632, the flat emitter 420 may be coupled to the second positioning support 812 at the second end 426 by sliding, pressing, snap-fitting, or otherwise inserting the emitter support 902 into one or more second cutout 620 of the flat emitter 420. In some examples, the flat emitter 420 may be welded or otherwise fixedly coupled to the second positioning support 812. The substantially flat sheet 610 that forms the flat emitter 420 may be in face-sharing contact with at least a portion of a planar support surface 912 of the second positioning support 812.

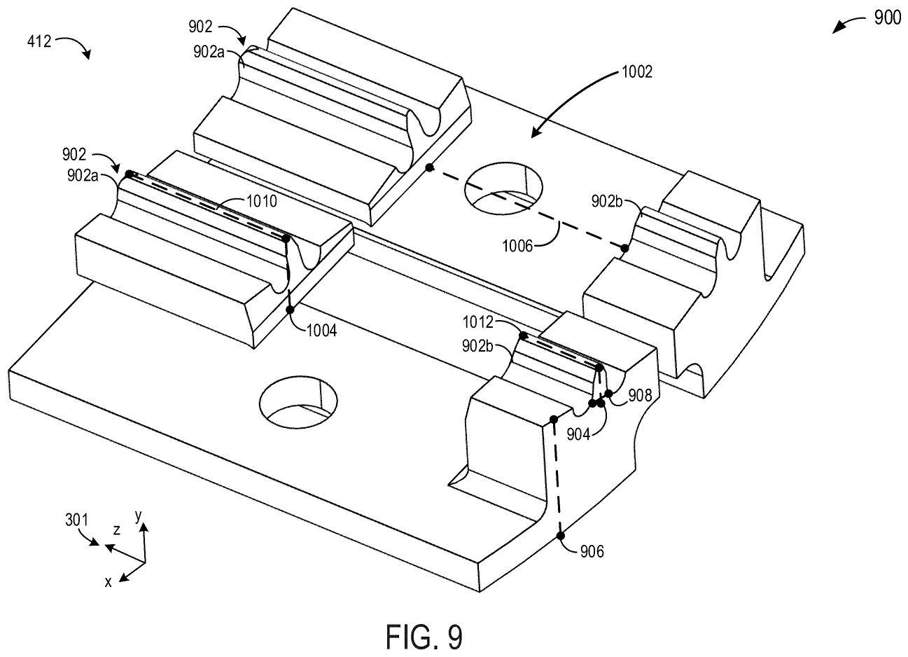

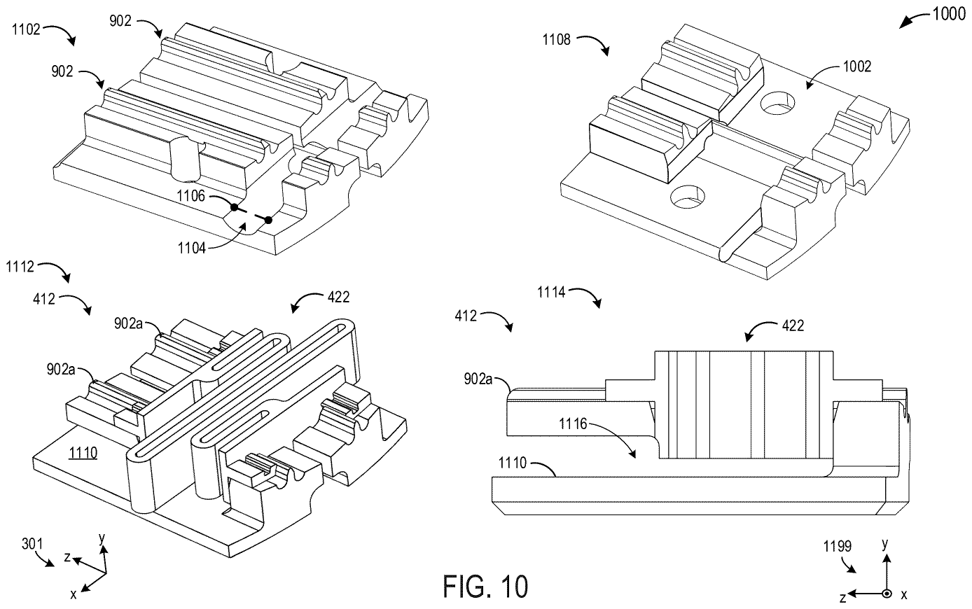

FIG. 9 shows a perspective view 900 of the first positioning support 412. The first positioning support 412 may be a machined version of the second positioning support 812, and thus may include some of the same elements. Elements of the second positioning support 812 that are included in the first positioning support 412 may be similarly numbered. In the first positioning support 412, one or more of the emitter support 902 may be sectioned into a first support section 902a and a second support section 902b. The first support section 902a may have a first section length 1010. The second support section 902b may have a second section length 1012. The first section length 1010 may be greater than the second section length 1012. The emitter support 902 is sectioned by a trench 1002 that extends through an emitter support height 1004 that includes the support height 904 and a portion of the base height 906. The trench 1002 extends between the first support section 902a and the second support section 902b. The trench 1002 has a trench width 1006 that is configured to be greater than a stress compensator width 802 (e.g., from the first coupling extension 726 to the second coupling extension 728, see FIG. 7) of the stress compensator 422. The groove 804 of the first coupling extension 726 and/or the second coupling extension 728 of the stress compensator 422 may be positioned laterally with respect to the emitter supports 902, as shown in FIG. 4. and further shown in FIG. 10. The stress compensator 422 may be fixedly coupled to the first positioning support 412. The first positioning support 412 may be coupled to the flat emitter 420 via the stress compensator 422.

FIG. 10 shows various views 1000 of the first positioning support 412 at various manufacturing stages. As briefly described above, the first positioning support 412 may be a machined version of the second positioning support 812. Elements of the first positioning support 412 that are described with respect to FIG. 9 may be similarly labeled and may not be reintroduced for brevity. The first positioning support 412 may be machined using electric discharge machining (EDM). A baseline configuration 1102 may include a channel 1104 cut in the emitter support 902. A channel width 1106 of the channel 1104 may be less than the trench width 1006 of the trench 1002. The channel 1104 may be further expanded to form the trench 1002 in a second machined support 1108. The trench 1002 may be machined out as a pocket in which to fit the stress compensator 422. The stress compensator 422 may be positioned in the trench 1002 of the second machined support 1108. In some examples, the stress compensator 422 may be welded into the second machined support 1108 of the first positioning support 412, such that the stress compensator 422 and the first positioning support 412 are a single, continuous piece. Once the stress compensator 422 is fixedly coupled to the first positioning support 412 in the trench 1002, further machining (e.g., EDM) may be performed to “release” the first support section 902a from a base 1110 of the first positioning support 412. A perspective view 1112 and a side view 1114 (refer to a third axis system 1199) of a final configuration of the first positioning support 412 show a vertical gap 1116 (e.g., parallel to the y-axis of the third axis system 1199) between the first support section 902a and the base 404, as well as between the stress compensator 422 and the base 404. The vertical gap 1116 may provide further compliance to both thermal and centrifugal stresses which may otherwise degrade the stress compensator 422 and/or the first positioning support 412 (e.g., if the vertical gap 1116 was not present and the first support section 902a and/or the stress compensator 422 were fixedly/rigidly coupled to the base 404). The second positioning support 812 may be continuous with the base 404, and may couple the stress compensator 422 and the first positioning support to the base 404. Further machining of the first positioning support 412 may include pencil blasting and additional cleaning, prior to being integrated in the cathode cup 402.

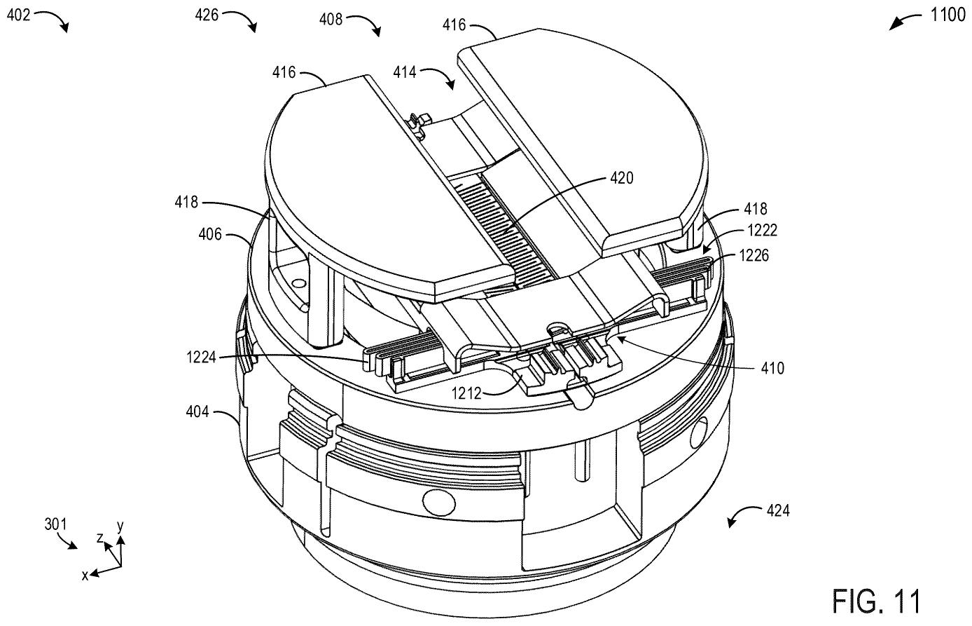

Different imaging systems and/or imaging procedures executed by the imaging system(s) may have different operating conditions. For example, some imaging procedures may include heating the flat emitter to temperatures below 2000 °C, while other imaging procedures may include heating the flat emitter to temperatures above 2000 °C. Further, some imaging procedures may include rotating the X-ray tube at a rate that exerts centrifugal forces on the flat emitter that are below 30 G, while other imaging procedures may include rotating the X-ray tube at a rate that exerts centrifugal forces on the flat emitter that are at or above 30 G. It may thus be desirable to tune an amount of thermal and centrifugal force experienced by the flat emitter by adjusting a configuration of the stress compensator. For example, the stress compensator 422 may have a second configuration that includes elements of the stress compensator 422 that are described with respect to FIGS. 4-10, as well as additional elements. These additional elements may enable a different amount of thermal and centrifugal stress compensation provided to the flat emitter 420 by the stress compensator 422 without departing from the geometry of the stress compensator 422, including a spring formed by a number of linear portions arranged in parallel, where each linear portion of the number of linear portions is coupled to a preceding and/or following linear portion by a turn. The second configuration is described herein with respect to FIGS. 11-18.

FIG. 11 shows a perspective view 1100 of a configuration of the cathode cup 402 that includes a second configuration 1222 of the stress compensator 422. Elements of the cathode cup 402, and/or elements coupled thereto, which are described with respect to FIGS. 4-11 are similarly numbered and may not be reintroduced. In the configuration described with respect to FIGS. 11-18, the cathode cup 402 includes a configuration of the emitter assembly 410 having the flat emitter 420, and the second configuration 1222 of the stress compensator 422. The second configuration 1222 of the stress compensator 422 may be formed of niobium, molybdenum, a steel alloy, a tungsten-uranium alloy, and/or another refractory material.

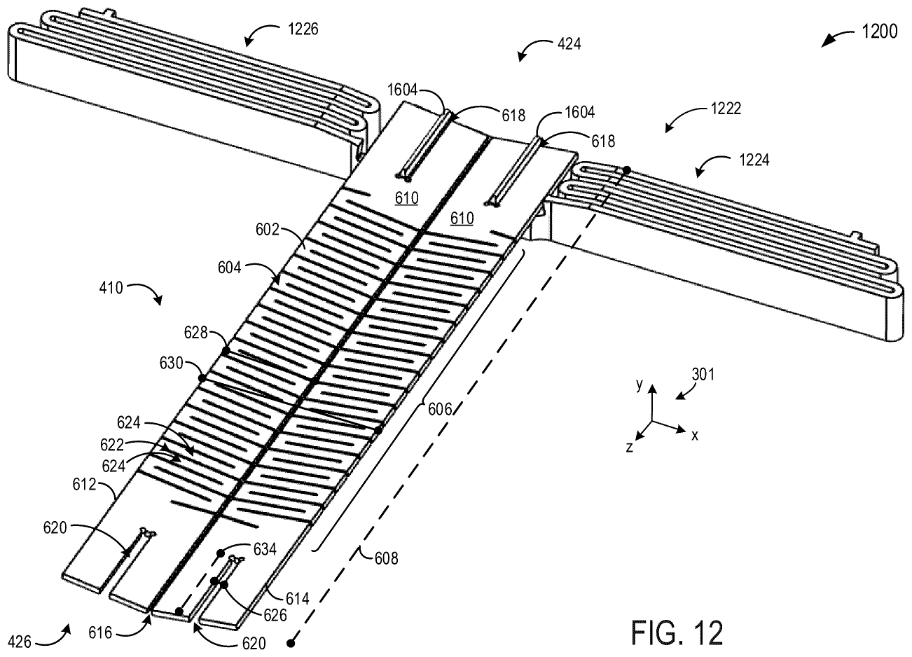

The geometry of the second configuration 1222 of the stress compensator 422 may demand changes to geometries of some other elements of the cathode cup 402 to accommodate the second configuration 1222 of the stress compensator 422. For example, the second configuration 1222 of the stress compensator 422 may include a first spring 1224 and a second spring 1226 coupled by a median (not visible in FIG. 12). One or more of the first spring 1224 and the second spring 1226 may be an example of the spring 702 of the stress compensator 422 described with respect to FIGS. 4-10. A third positioning support 1212 is positioned at the first end 424 of the cathode cup 402 (e.g., in place of the first positioning support 412) and a fourth positioning support (not shown in FIG. 11) is positioned at the second end 426 of the cathode cup 402 (e.g., in place of the second positioning support 812). The emitter assembly 410 may be positioned in the cathode cup 402 by coupling the stress compensator 422 to the third positioning support 1212 and coupling the flat emitter 420 to the fourth positioning support.

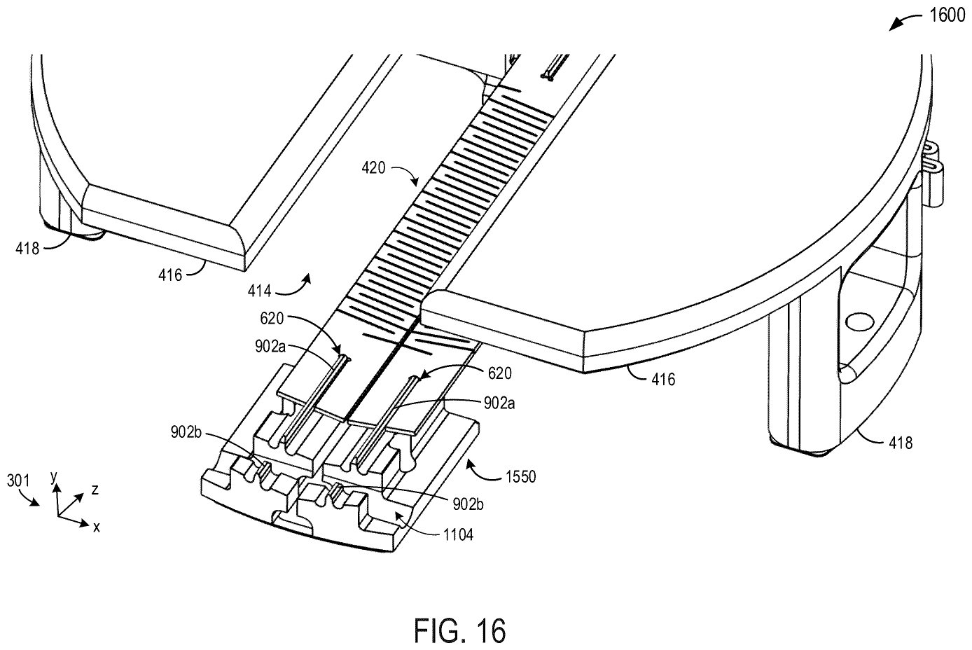

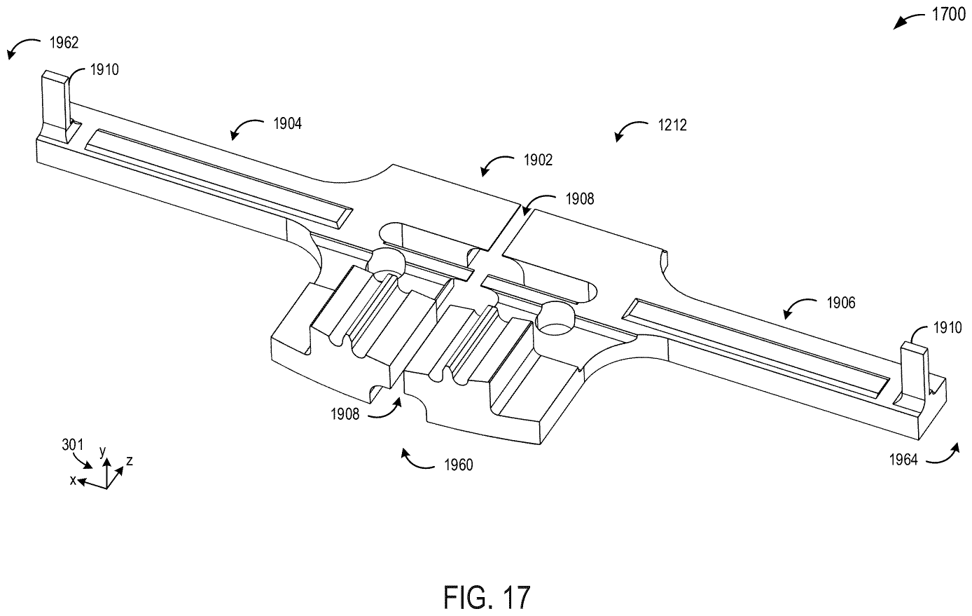

The third positioning support 1212 may be coupled to the insulator 406 at the first end 424. The fourth positioning support may be coupled to the insulator 406 at the second end 426, as further described with respect to FIG. 17. Further detail regarding geometry of each of the third positioning support 1212 and the fourth positioning support are described with respect to FIGS. 16-18.

One or more leads of the series of electrical leads 356 (e.g., ribbons, wires, cables, pins or other electrical connection components) may be coupled to each of the third positioning support 1212 and the fourth positioning support. Current may be supplied to the third positioning support 1212 and/or to the fourth positioning support to heat up the flat emitter 420 of the emitter assembly 410 to a temperature at which the flat emitter 420 emits electrons.

FIG. 12 shows a perspective view 1200 of the emitter assembly 410 of the cathode cup 402. As briefly described with respect to FIG. 11, the emitter assembly 410 comprises the flat emitter 420 and the second configuration 1222 of the stress compensator 422. Elements of the flat emitter 420 that are described with respect to FIG. 5 are similarly numbered and may not be reintroduced. In the configuration of the emitter assembly 410 described with respect to FIGS. 4-10, the spring 702 of the stress compensator 422 is positioned axially in line (e.g., along the z-axis of the axis system 301) with the flat emitter 420. In the second configuration 1222, the stress compensator 422 may be selectively coupled to the first end 424 of the flat emitter 420, where the first spring 1224 and the second spring 1226 of the stress compensator 422 are positioned perpendicular to the flat emitter 420. The median (not visible in FIG. 12) is axially in line with the flat emitter 420 (e.g., along the z-axis of the axis system 301). The first spring 1224 and the second spring 1226 may be axially in line with each other (e.g., along the x-axis of the axis system 301) and with the first width 626 of the first cutouts 618 of the flat emitter 420 at the first end 424.

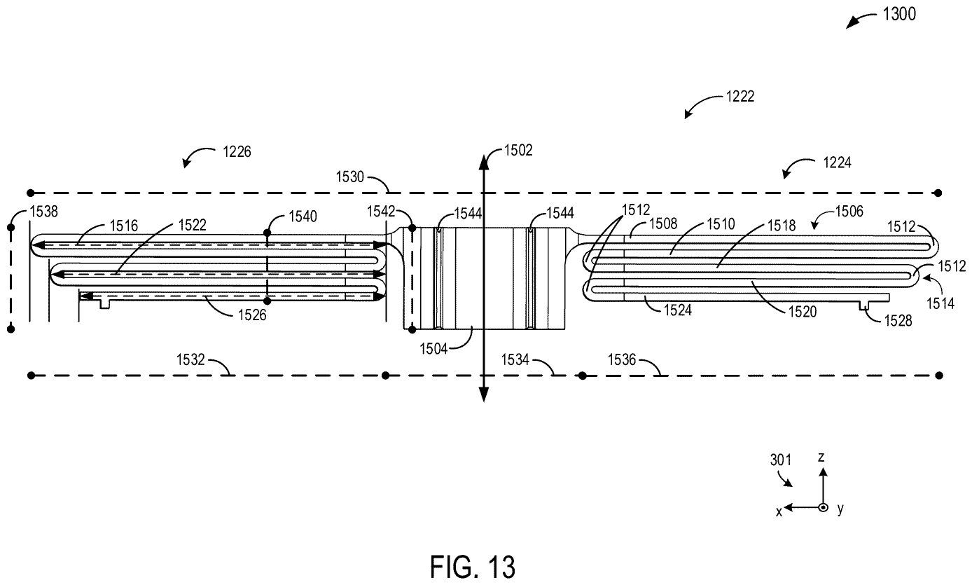

FIG. 13 shows a top-down view 1300 of the second configuration 1222 of the stress compensator 422. Similar to the configuration of the stress compensator 422 described with respect to FIGS. 4-10, the second configuration 1222 of the stress compensator 422 comprises a spring formed by a number of linear portions arranged in parallel, where each linear portion of the number of linear portions is coupled to a preceding and/or following linear portion by a turn. The second configuration 1222 includes the first spring 1224 and the second spring 1226. Each of the first spring 1224 and the second spring 1226 may be examples of the spring 702 of the stress compensator 422, where each of the first spring 1224 and the second spring 1226 are formed by a number of linear portions arranged in parallel and with each linear portion coupled to a preceding and/or following linear portion by a turn. Configurations of the first spring 1224 and the second spring 1226 may be mirrored across a central plane 1502 (e.g., the z-y plane) of the second configuration 1222 of the stress compensator 422. The second spring 1226 is coupled to the first spring 1224 by via a median 1504 that is positioned between the first spring 1224 and the second spring 1226 such that the first spring 1224, the median 1504, and the second spring 1226 are positioned in series (e.g., along the x-axis of the axis system 301).

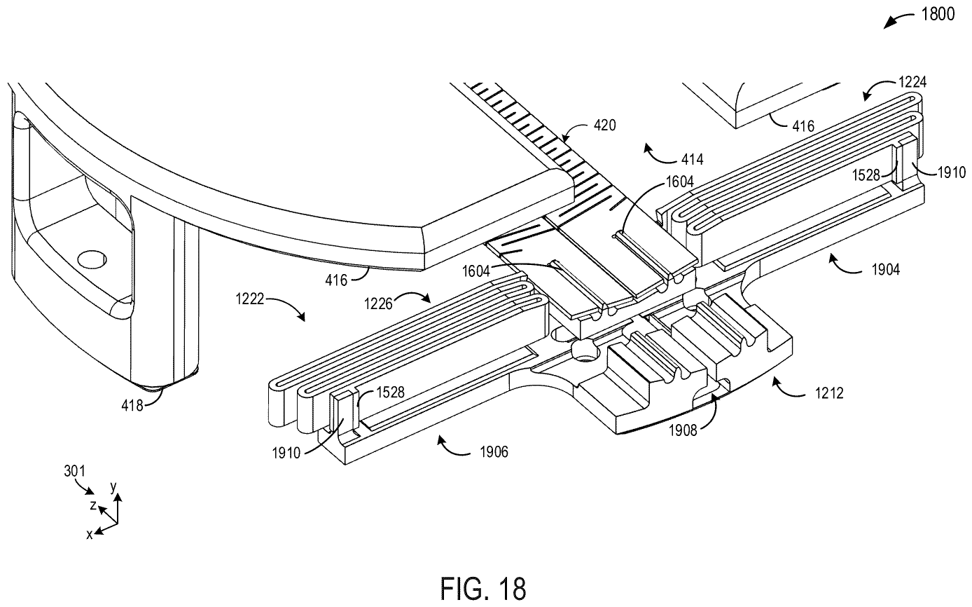

The first spring 1224 and the second spring 1226 are each formed of a continuous, serpentine path. Each of the first spring 1224 and the second spring 1226 comprise a first ribbon 1506 formed of a first linear portion 1508 and a second linear portion 1510. The first linear portion 1508 and the second linear portion 1510 are coupled by a turn 1512. The first ribbon 1506 has a first length 1516. The first spring 1224 and the second spring 1226 further comprise a second ribbon 1514 that is coupled to the first ribbon 1506 by the turn 1512. The second ribbon 1514 is formed of a third linear portion 1518 and a fourth linear portion 1520. The third linear portion 1518 and the fourth linear portion 1520 are coupled by the turn 1512. The second ribbon 1514 has a second length 1522. The second length 1522 of the second ribbon 1514 may be less than the first length 1516 of the first ribbon 1506. The first spring 1224 and the second spring 1226 further comprise a leg 1524 that is coupled to the second ribbon 1514 via the turn 1512. The leg 1524 has a third length 1526. The third length 1526 may be less than the second length 1522 of the second ribbon 1514. The leg 1524 may further include a positioning extension 1528 that extends perpendicular to the third length 1526 of the leg 1524. The positioning extension 1528 may assist in positioning the second configuration 1222 of the stress compensator 422 in the third positioning support 1212, as further described with respect to FIG. 18. The first ribbon 1506, the second ribbon 1514, and the leg 1524 may be arranged in parallel. The second configuration 1222 of the stress compensator 422 further is formed of a single continuous serpentine path that extends from the leg 1524 of the first spring 1224, across the median 1504, and to the leg 1524 of the second spring 1226.

A length 1530 of the second configuration 1222 of the stress compensator 422 includes a first spring length 1532 of the first spring 1224, a second spring length 1536 of the second spring 1226, and a median length 1534 of the median 1504. Each of the first spring length 1532 and the second spring length 1536 may be equal to the first length 1516 of the first ribbon 1506. A width 1538 of the second configuration 1222 of the stress compensator 422 includes a spring width 1540 of the first spring 1224 and the second spring 1226, and a median width 1542 of the median 1504. The median width 1542 may be greater than the spring width 1540. The width 1538 may be equal to the median width 1542. A ratio of the length 1530 and the width 1538 of the second configuration 1222 of the stress compensator 422 may be greater than or equal to ten. The ratio of the length 1530 and the width 1538, the number of linear portions, and/or the number of ribbons of each of the first spring 1224 and the second spring 1226 may be tuned such that the second configuration 1222 of the stress compensator 422 provides compliance to give the flat emitter 420 the same stiffness along the emitter length 1608.

The median 1504 comprises one or more of an emitter support 1544. The emitter support 1544 has geometry that may be complementary to, and enable coupling of the stress compensator 422 with, an emitter (e.g., the flat emitter 420). Geometry of the emitter support 1544 may be adjusted based on a type of emitter to which the stress compensator 422 is to be coupled. For example, in emitter assemblies where a single pass emitter is used, the median 1504 may include a single emitter support 1544.

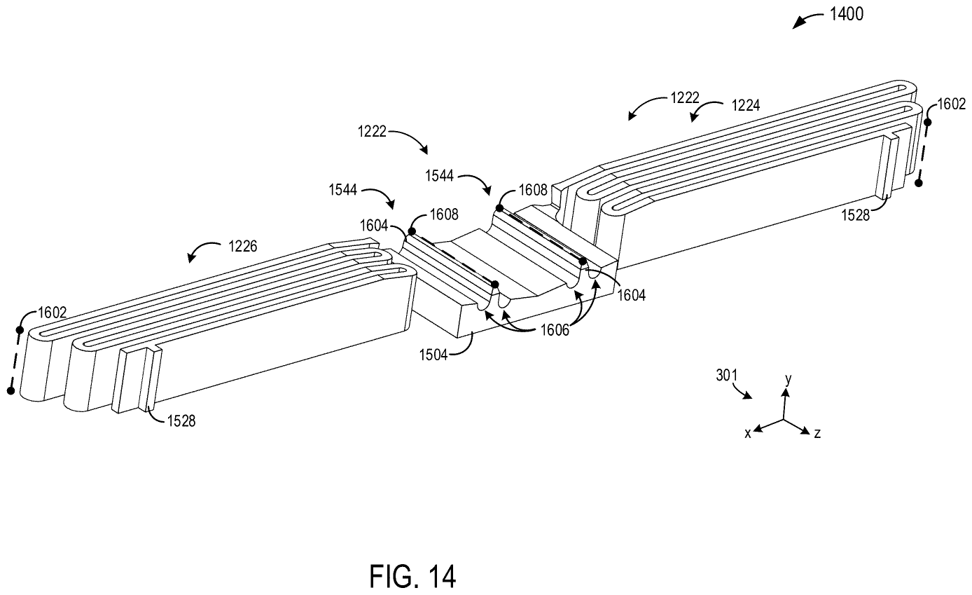

Turning to FIG. 14, a perspective view 1400 is shown of the second configuration 1222 of the stress compensator 422. The second configuration 1222 of the stress compensator 422 may provide a higher first resonance mode, compared to the stress compensator 422 described with respect to FIGS. 4-10. A height 1602 of the first spring 1224 and/or the second spring 1226 may be adjusted (e.g., independent of each other) to tune the second configuration 1222 of the stress compensator 422, which may provide increased stiffness in the normal direction. This may result in an increased first modal frequency. Further, the second configuration 1222 of the stress compensator 422 may have a reduced moment arm and corresponding deflection due to a coupling of the stress compensator 422 being closer in proximity to the flat emitter 420. The emitter support 1544 of the median 1504 may include a vertical extension 1604 positioned between two grooves 1606. The vertical extension 1604 may extend a support length 910 that is less than or equal to the cutout length 634 of the first cutout 618 of the flat emitter 420.

Returning to FIG. 12, the vertical extension 1604 of the emitter support 1544 is shown positioned in the first cutout 618 of the flat emitter 420 at the first end 424 to selectively couple the stress compensator 422 to the flat emitter 420. The flat emitter 420 may be coupled to the second configuration 1222 of the stress compensator 422 by sliding, pressing, snap-fitting, welding, brazing, or otherwise inserting the emitter support 1544 of the median 1504 of the second configuration 1222 of the stress compensator 422 into one or more of the first cutout 618 of the flat emitter 420. In some examples, the flat emitter 420 may be welded or otherwise fixedly coupled to the second configuration 1222 of the stress compensator 422 via the emitter support 1544. Welding the second configuration 1222 of the stress compensator 422 to the flat emitter 420 via the emitter support 1544 may allow the second configuration 1222 of the stress compensator 422 to conduct current. When the flat emitter 420 is formed of two independent single passes (e.g., the first pass 612 and the second pass 614), welding both of the first pass 612 and the second pass 614 to the second configuration 1222 of the stress compensator 422 enables current to be conducted to each of the first pass 612 and the second pass 614, thus removing demand for an emitter-emitter weld between the first pass 612 and the second pass 614.

Positioning the emitter assembly 410 having the second configuration 1222 of the stress compensator 422 in a cathode cup (e.g., the cathode cup 402) may include additional manufacturing demands for the cathode cup. In the emitter assembly 410 described herein, the second configuration 1222 of the stress compensator 422 may be selectively coupled to the flat emitter 420 at the first end 424, and the flat emitter 420 may be selectively coupled to the fourth positioning support at the second end 426. The second configuration 1222 of the stress compensator 422 may be coupled to and positioned in the cathode cup 402 by the third positioning support 1212 at the first end 424. The third positioning support 1212 and the fourth positioning support 1550 may have different geometries in order to accommodate the second configuration 1222 of the stress compensator 422 and the flat emitter 420, respectively.

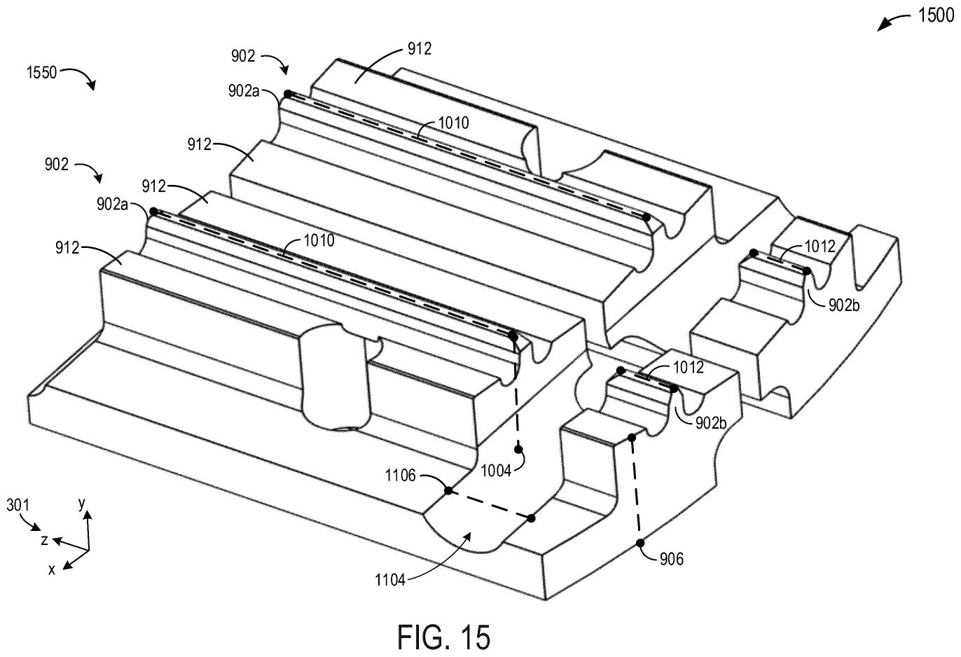

FIG. 15 shows a perspective view 1500 of a fourth positioning support 1550 (e.g., the fourth positioning support described with respect to FIGS. 11-14). The fourth positioning support 1550 may be an adapted version of the second positioning support 812 described with respect to FIG. 8. The fourth positioning support 1550 may thus include some elements that are included in and described with respect to the second positioning support 812. Elements of the second positioning support 812 that are included in the fourth positioning support 1550 may be similarly numbered and not reintroduced. Similar to the baseline configuration 1102, the fourth positioning support 1550 may include a channel 1104 cut in the emitter support 902. The channel 1104 may have a channel width 1106. The channel 1104 may section the emitter support 902 into the first support section 902a having the first section length 1010, and the second support section 902b having the second section length 1012. The first section length 1010 may be greater than the second section length 1012. The channel 1104 may extend parallel to, and a portion of, the base height 906.

FIG. 16 shows a perspective view 1600 of the flat emitter 420 coupled to the fourth positioning support 1550. The first support section 902a is shown positioned in the second cutout 620 of the flat emitter 420 at the second end 426 to selectively couple the flat emitter 420 to the fourth positioning support 1550. The flat emitter 420 may be coupled to the fourth positioning support 1550 by sliding, pressing, snap-fitting, or otherwise inserting one or more of the first support section 902a of the fourth positioning support 1550 into one or more of the second cutout 620 of the flat emitter 420.

FIG. 17 shows a perspective view 1700 of the third positioning support 1212. The third positioning support 1212 may be formed of niobium, in some examples. The third positioning support 1212 includes a central body 1902, a first arm 1904, and a second arm 1906. The central body 1902 may be planar on a third side 1960 (e.g., the x-z plane, with respect to the axis system 301). The central body 1902 may include a relief 1908 cut into the planar surface on the third side 1960. The relief 1908 may be configured to space a portion of the central body 1902 away from the insulator 406 (e.g., such that there is a gap therebetween) when the third positioning support 1212 is positioned in the cathode cup 402 (e.g., as shown in FIG. 11). The relief 1908 may further act as a pocket that creates clearance for positioning the second configuration 1222 of the stress compensator 422 during a manufacturing (e.g., rough EDM) process.

The first arm 1904 and the second arm 1906 each extend laterally from the central body (e.g., along the x-axis) on a first side 1962 and a second side 1964, respectively. Each of the first arm 1904 and the second arm 1906 include a wing 1910 that extends vertically (e.g., parallel to the y-axis) from the first arm 1904 and/or the second arm 1906. The wing 1910 may be a weld element at which the second configuration 1222 of the stress compensator 422 may be welded to the third positioning support 1212, as further described with respect to FIG. 18.

FIG. 18 shows a perspective view 1800 of the second configuration 1222 of the stress compensator 422 positioned in the third positioning support 1212. The third positioning support 1212 is configured to be positioned in face-sharing contact with the second configuration 1222 of the stress compensator 422. The relief 1908 of the central body 1902 and the wing 1910 of each of the first arm 1904 and the second arm 1906 may be self fixturing elements that provide rigid support to assist in positioning the stress compensator 422 in the third positioning support 1212 during manufacturing and assembly of the cathode cup 402. For example, the wing 1910 of the first arm 1904 and the wing 1910 of the second arm 1906 are in face-sharing contact with the positioning extension 1528 of the leg 1524 of each of the first spring 1224 and the second spring 1226, respectively.

In this way, a stress compensator of an emitter assembly is provided which enables thermal expansion of the emitter. The stress compensator may be selectively integrated into a cathode, and may thus be removable and interchanged with (e.g., replace) existing cathode emitter support structures. Compared to conventional, existing cathode emitter support structures, the stress compensator described herein increases reliability and performance of the cathode emitter by increasing modal frequencies, reducing plastic deformation, and reducing stress of the cathode emitter. This may reduce shorting due to compression, such as may occur in fixed emitters (e.g., fixed in six degrees of freedom from the first end and the second end) due to thermal expansion of the emitter and/or G force/centrifugal forces experienced by the emitter. The stress compensator is configured to compensate for thermal expansion and centrifugal force stresses on the flat emitter during execution of a method where the stress compensator and the flat emitter are positioned in the cathode assembly using a first positioning support at a first end and a second positioning support at a second end, opposite the first end, and operating the X-ray tube to emit electrons from the flat emitter by causing the flat emitter to reach temperatures above 2000 °C and experience centrifugal forces above 20 G. When coupled to the flat emitter, the stress compensator may provide similar stress within the emission surface of the flat emitter for comparative load cases where a spring element of a stress compensator is directly integrated into the emitter. Deformation due to thermal expansion and/or centrifugal force that would conventionally be experienced by the emitter is directed to the stress compensator, where a spring of the stress compensator distributes deforming forces, thus reducing stresses on the emitter and increasing a useable life of the emitter. During operation of the X-ray beam, which may include rotation of the X-ray beam and heating of the emitter, compression of the emitter and possible shorting of the emitter due to compression may be mitigated, as centrifugal forces and thermal expansion of the emitter may be directed to temporary deformation of the stress compensator. The cathode may thus have increased reliability and X-ray beam emission performance. The technical effect of a cathode for an imaging system as described herein is increased electron focusing ability of the cathode, high-voltage stability of the cathode, and increased yield of manufactured cathodes.

The disclosure also provides support for an emitter assembly, comprising: a flat emitter formed as a planar emission surface having a serpentine pattern, and a stress compensator that is selectively coupled to the flat emitter at a first end of the flat emitter, the stress compensator comprising a spring formed by a number of linear portions arranged in parallel, where each linear portion of the number of linear portions is coupled to a preceding and/or following linear portion by a turn. In a first example of the system, a first linear portion of the number of linear portions of the spring has a first length, a second linear portion of the number of linear portions of the spring has a second length, and a ratio of the second length to the first length is greater than or equal to three. In a second example of the system, optionally including the first example, a third linear portion of the number of linear portions of the spring has a third length that is greater than each of the first length and the second length. In a third example of the system, optionally including one or both of the first and second examples, a fourth linear portion of the number of linear portions of the spring has the second length, and a fifth linear portion of the number of linear portions of the spring has the first length. In a fourth example of the system, optionally including one or more or each of the first through third examples, the stress compensator further comprises a first coupling extension coupled to the first linear portion and a second coupling extension coupled to the fifth linear portion. In a fifth example of the system, optionally including one or more or each of the first through fourth examples, the stress compensator further includes a second spring that is coupled to the spring via a median positioned between the spring and the second spring, such that the spring, the median, and the second spring are positioned in series. In a sixth example of the system, optionally including one or more or each of the first through fifth examples, the median comprises an emitter support. In a seventh example of the system, optionally including one or more or each of the first through sixth examples, the spring and the second spring each comprise a first ribbon formed of a first linear portion and a second linear portion of the number of linear portions, a second ribbon that is coupled to the first ribbon and formed of a third linear portion and a fourth linear portion of the number of linear portions, and a leg of the number of linear portions that is coupled to the second ribbon, where each of the first ribbon, the second ribbon, and the leg are arranged in parallel. In an eighth example of the system, optionally including one or more or each of the first through seventh examples, the first ribbon has a first length, the second ribbon has a second length that is less than the first length, and the leg has a third length that is less than the second length. In a ninth example of the system, optionally including one or more or each of the first through eighth examples, the leg includes a positioning extension that extends perpendicular to the first ribbon, the second ribbon, and the leg. In a tenth example of the system, optionally including one or more or each of the first through ninth examples, configurations of the spring and the second spring are mirrored across a central plane of the stress compensator. In a eleventh example of the system, optionally including one or more or each of the first through tenth examples,: a length of the stress compensator includes a first spring length of the spring, a second spring length of the second spring, and a median length of the median, a width of the stress compensator includes a spring width of the spring and the second spring, and a median width of the median, and wherein a ratio of the length and the width of the stress compensator is greater than or equal to ten. In a twelfth example of the system, optionally including one or more or each of the first through eleventh examples, the stress compensator is formed of niobium, molybdenum, a steel alloy, a tungsten-uranium alloy, and/or another refractory material.

The disclosure also provides support for an X-ray tube, comprising: a cathode assembly including an emitter assembly, and an anode assembly spaced apart from the cathode assembly, wherein the emitter assembly comprises: a flat emitter formed as a planar emission surface with a serpentine pattern, and a stress compensator that is selectively coupled to the flat emitter at a first end of the flat emitter, the stress compensator comprising a spring formed by a number of linear portions arranged in parallel, where each linear portion of the number of linear portions is coupled to a preceding and/or following linear portion by a turn. In a first example of the system, the cathode assembly comprises a cathode cup, including: a base, a focusing element, a first positioning support and a second positioning support, an insulator positioned between the base and the focusing element, the first positioning support, and the second positioning support, where the insulator configured to electrically isolate the base from the focusing element, the first positioning support, and the second positioning support, and the emitter assembly, where the emitter assembly is positioned in the cathode cup by coupling the stress compensator to the first positioning support and coupling the flat emitter to the second positioning support. In a second example of the system, optionally including the first example, the flat emitter comprises a first cutout at the first end and a second cutout at a second end opposite the first end, where both the first cutout and the second cutout extend through the planar emission surface. In a third example of the system, optionally including one or both of the first and second examples, the second positioning support comprises an emitter support that is complementary to the first cutout and/or the second cutout of the flat emitter. In a fourth example of the system, optionally including one or more or each of the first through third examples, the first positioning support comprises, an emitter support having a first support section and a second support section, where the emitter support is complementary to the first cutout and/or the second cutout of the flat emitter, and a trench that extends between the first support section and the second support section, where the trench is configured to have the stress compensator positioned therein. In a fifth example of the system, optionally including one or more or each of the first through fourth examples, the stress compensator is fixedly coupled to the first positioning support.

The disclosure also provides support for a cathode cup, comprising: a base, a focusing element, a first positioning support and a second positioning support, an insulator positioned between the base and the focusing element, the first positioning support, and the second positioning support, where the insulator configured to electrically isolate the base from the focusing element, the first positioning support, and the second positioning support, and an emitter assembly comprising a flat emitter formed as a planar emission surface with a serpentine pattern and a stress compensator that is selectively coupled to the flat emitter at a first end of the flat emitter, the stress compensator comprising a spring formed by a number of linear portions arranged in parallel where each linear portion of the number of linear portions is coupled to a preceding and/or following linear portion by a turn, and where the emitter assembly is positioned in the cathode cup by coupling the stress compensator to the first positioning support and coupling the flat emitter to the second positioning support.

FIGS. 3-18 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, an element or step recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An emitter assembly, comprising:
a flat emitter formed as a planar emission surface having a serpentine pattern; and
a stress compensator that is selectively coupled to the flat emitter at a first end of the flat emitter, the stress compensator comprising a spring formed by a number of linear portions arranged in parallel, where each linear portion of the number of linear portions is coupled to a preceding and/or following linear portion by a turn.

2. The emitter assembly of claim 1, wherein a first linear portion of the number of linear portions of the spring has a first length, a second linear portion of the number of linear portions of the spring has a second length, and a ratio of the second length to the first length is greater than or equal to three.

3. The emitter assembly of claim 2, wherein a third linear portion of the number of linear portions of the spring has a third length that is greater than each of the first length and the second length.

4. The emitter assembly of claim 2, wherein a fourth linear portion of the number of linear portions of the spring has the second length, and a fifth linear portion of the number of linear portions of the spring has the first length.

5. The emitter assembly of claim 4, wherein the stress compensator further comprises a first coupling extension coupled to the first linear portion and a second coupling extension coupled to the fifth linear portion.

6. The emitter assembly of claim 1, wherein the stress compensator further includes a second spring that is coupled to the spring via a median positioned between the spring and the second spring, such that the spring, the median, and the second spring are positioned in series.

7. The emitter assembly of claim 6, wherein the median comprises an emitter support.

8. The emitter assembly of claim 6, wherein the spring and the second spring each comprise a first ribbon formed of a first linear portion and a second linear portion of the number of linear portions, a second ribbon that is coupled to the first ribbon and formed of a third linear portion and a fourth linear portion of the number of linear portions, and a leg of the number of linear portions that is coupled to the second ribbon, where each of the first ribbon, the second ribbon, and the leg are arranged in parallel.

9. The emitter assembly of claim 8, wherein the first ribbon has a first length, the second ribbon has a second length that is less than the first length, and the leg has a third length that is less than the second length.

10. The emitter assembly of claim 8, wherein the leg includes a positioning extension that extends perpendicular to the first ribbon, the second ribbon, and the leg.

11. The emitter assembly of claim 6, wherein configurations of the spring and the second spring are mirrored across a central plane of the stress compensator.

12. The emitter assembly of claim 6, wherein:
a length of the stress compensator includes a first spring length of the spring, a second spring length of the second spring, and a median length of the median;
a width of the stress compensator includes a spring width of the spring and the second spring, and a median width of the median; and
wherein a ratio of the length and the width of the stress compensator is greater than or equal to ten.

13. The emitter assembly of claim 1, wherein the stress compensator is formed of niobium, molybdenum, a steel alloy, a tungsten-uranium alloy, and/or another refractory material.

14. An X-ray tube, comprising:
a cathode assembly including an emitter assembly; and
an anode assembly spaced apart from the cathode assembly, wherein the emitter assembly comprises:
a flat emitter formed as a planar emission surface with a serpentine pattern; and
a stress compensator that is selectively coupled to the flat emitter at a first end of the flat emitter, the stress compensator comprising a spring formed by a number of linear portions arranged in parallel, where each linear portion of the number of linear portions is coupled to a preceding and/or following linear portion by a turn.

15. The X-ray tube of claim 14, wherein the cathode assembly comprises a cathode cup, including:
a base;
a focusing element;
a first positioning support and a second positioning support;
an insulator positioned between the base and the focusing element, the first positioning support, and the second positioning support, where the insulator configured to electrically isolate the base from the focusing element, the first positioning support, and the second positioning support; and
the emitter assembly, where the emitter assembly is positioned in the cathode cup by coupling the stress compensator to the first positioning support and coupling the flat emitter to the second positioning support.

16. The X-ray tube of claim 15, wherein the flat emitter comprises a first cutout at the first end and a second cutout at a second end opposite the first end, where both the first cutout and the second cutout extend through the planar emission surface.

17. The X-ray tube of claim 16, wherein the second positioning support comprises an emitter support that is complementary to the first cutout and/or the second cutout of the flat emitter.

18. The X-ray tube of claim 16, wherein the first positioning support comprises;
an emitter support having a first support section and a second support section, where the emitter support is complementary to the first cutout and/or the second cutout of the flat emitter; and
a trench that extends between the first support section and the second support section, where the trench is configured to have the stress compensator positioned therein.

19. The X-ray tube of claim 15, wherein the stress compensator is fixedly coupled to the first positioning support.

20. A cathode cup, comprising:
a base;
a focusing element;
a first positioning support and a second positioning support;
an insulator positioned between the base and the focusing element, the first positioning support, and the second positioning support, where the insulator configured to electrically isolate the base from the focusing element, the first positioning support, and the second positioning support; and
an emitter assembly comprising a flat emitter formed as a planar emission surface with a serpentine pattern and a stress compensator that is selectively coupled to the flat emitter at a first end of the flat emitter, the stress compensator comprising a spring formed by a number of linear portions arranged in parallel where each linear portion of the number of linear portions is coupled to a preceding and/or following linear portion by a turn, and where the emitter assembly is positioned in the cathode cup by coupling the stress compensator to the first positioning support and coupling the flat emitter to the second positioning support.
